(19) United States
(12) Patent Application Publication
(10) Pub. No.: US 2024/0351786 A1
(43) Pub. Date: Oct. 24, 2024

(54) CONVEYANCE SYSTEM

(71) Applicant: TOYOTA JIDOSHA KABUSHIKI KAISHA, Aichi-ken (JP)

(72) Inventors: Hirotaka KOMURA, Tokyo-to (JP); Yoshitaka HADA, Toyota-shi (JP)

(73) Assignee: TOYOTA JIDOSHA KABUSHIKI KAISHA, Aichi-ken (JP)

(21) Appl. No.: 18/624,120

(22) Filed: Apr. 2, 2024

(30) Foreign Application Priority Data
Apr. 18, 2023 (JP) 2023-067763

(51) Int. Cl. B65G 1/127; B65G 43/08; F16H 19/06

(52) U.S. Cl. CPC B65G 1/127; B65G 43/08; F16H 19/06

(57) ABSTRACT

A conveyance system for improving the lifespan of an expandable pipe structure formed by spirally winding two belts is achieved. A conveyance system according to one embodiment of the present disclosure includes a pipe structure formed by spirally winding a first belt and a second belt arranged inside the first belt around an axis, a drive unit configured to vertically expand and contract the pipe structure, a mounting unit attached to a tip of the pipe structure, and a control unit configured to select a height at which the mounting unit is to be stopped from among a plurality of candidates for the height based on a height history of the heights at which the mounting unit has stopped in the past.

### CROSS REFERENCE TO RELATED APPLICATIONS

This application is based upon and claims the benefit of priority from Japanese patent application No. 2023-067763, filed on Apr. 18, 2023, the disclosure of which is incorporated herein in its entirety by reference.

### BACKGROUND

The present disclosure relates to a conveyance system.

Japanese Unexamined Patent Application Publication No. 2021-173391 discloses a technique for forming an extension pipe by spirally guiding a first belt having engagement pins formed along long sides facing each other and a second belt having engagement holes formed along the long sides facing each other.

### SUMMARY

A relatively large stress is generated at the point where winding of the first belt and the second belt is started. This stress may reduce the durability of the extension pipe.

The present disclosure has been made in view of such problem, and provides a conveyance system for improving the lifespan of an expandable pipe structure formed by spirally winding two belts.

In an aspect of the present disclosure, a conveyance system includes:
a pipe structure formed by spirally winding a first belt and a second belt arranged inside the first belt around an axis;
a drive unit configured to vertically expand and contract the pipe structure;
a mounting unit attached to a tip of the pipe structure; and
a control unit configured to select a height at which the mounting unit is to be stopped from among a plurality of candidates for the height based on a height history of the heights at which the mounting unit has stopped in the past.

According to the present disclosure, it is possible to achieve a conveyance system for improving the lifespan of an expandable pipe structure formed by spirally winding two belts.

The above and other objects, features and advantages of the present disclosure will become more fully understood from the detailed description given hereinbelow and the accompanying drawings which are given by way of illustration only, and thus are not to be considered as limiting the present disclosure.

### BRIEF DESCRIPTION OF DRAWINGS

FIG. 1 is an explanatory diagram showing a configuration of an expandable apparatus according to a reference example;

FIG. 2 is an explanatory diagram showing a configuration of the expandable apparatus according to the reference example;

FIG. 3 is a diagram for explaining a configuration example of a conveyance robot according to a first embodiment;

FIG. 4 is a diagram for explaining a configuration example of the conveyance robot according to the first embodiment;

FIG. 5 is an explanatory diagram showing a configuration of a shelf according to the first embodiment; and

FIG. 6 is a diagram for explaining an operation example of the conveyance robot according to the first embodiment.

### DESCRIPTION OF EMBODIMENTS

### Reference Example

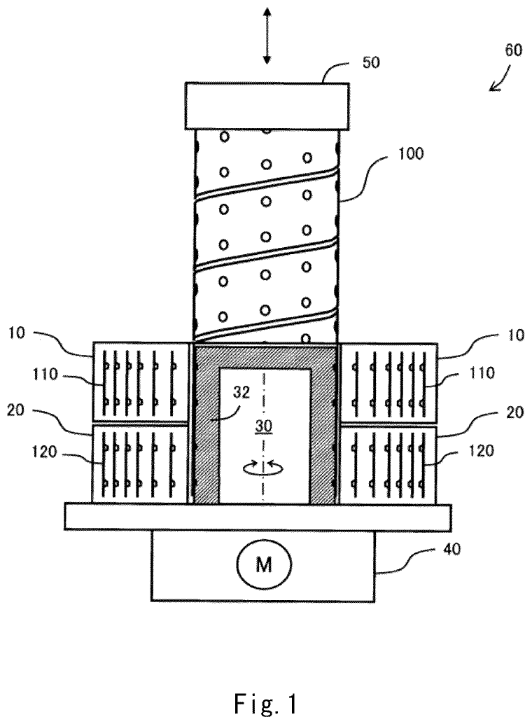

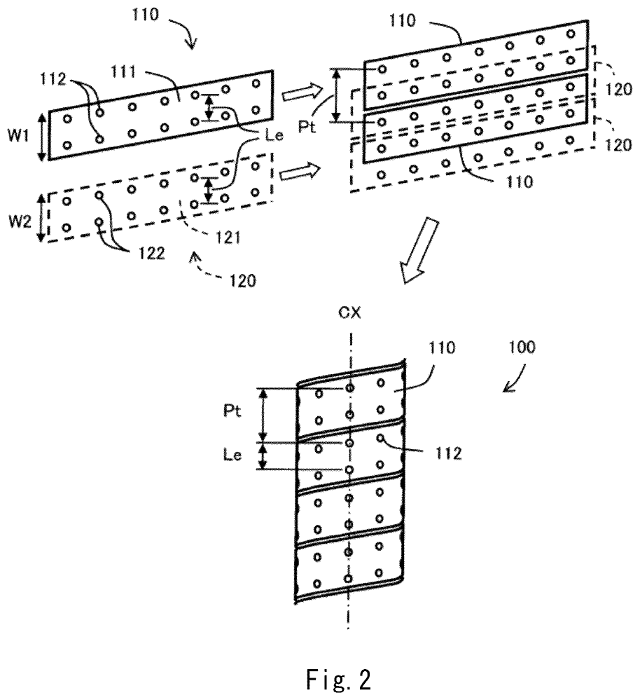

Referring to FIGS. 1 and 2, an expandable apparatus 60 according to a reference example will be described. FIG. 1 is an explanatory diagram showing a configuration of the expandable apparatus 60 including an pipe structure.

The expandable apparatus 60 according to this reference example has a pipe structure 100, a first housing unit 10, a second housing unit 20, a guide unit 30, a drive unit 40, and a mounting unit 50. The pipe structure 100 is formed by spirally winding the first belt 110 and the second belt 120. The first housing unit 10 houses the first belt 110. The second housing unit 20 houses the second belt 120. The guide unit 30 guides the first belt 110 and the second belt 120 and spirally winds them. The drive unit 40 rotates a guide member 32 of the guide unit 30. The mounting unit 50 is attached to a tip of the pipe structure 100.

When the guide member 32 is driven by the drive unit 40 to rotate in one direction, the first belt 110 and the second belt 120 are spirally wound guided by the guide member 32, and the pipe structure 100 extends upward in FIG. 1. When the guide member 32 rotates in the opposite direction, the winding of the first belt 110 and the second belt 120 is released, and the first belt 110 and the second belt 120 are accommodated in the first housing unit 10 and the second housing unit 20, respectively, causing the pipe structure 100 to contract. Note that instead of rotating the guide member 32, the pipe structure 100 itself may be rotated to expand or contract the pipe structure. The first belt 110 and the second belt 120 may be formed of metal (e.g., metal having spring properties such as spring stainless steel). The first belt 110 and the second belt 120 may be formed of other materials such as deformable resin.

FIG. 2 is an explanatory diagram showing how the pipe structure 100 is formed by winding the first belt 110 and the second belt 120. In FIG. 2, the outer shape of the second belt 120 is drawn with a dashed line for convenience of illustration. The upper left corner of FIG. 2 shows the state before winding, and the upper right corner shows the overlapping of the first belt 110 and the second belt 120 in the wound state, flattened in a plane.

The pipe structure 100 is formed by spirally winding the first belt 110 and the second belt 120 disposed inside the first belt 110 around an axis CX. The first belt 110 has a first flat band part 111 and a plurality of first engaging parts 112 arranged in a plurality of rows along the longitudinal direction of the first belt 110. The first flat band part 111 is a flat band-like part without protrusions or recesses. The first engaging parts 112 are arranged in two rows at regular intervals along the longitudinal direction of the first belt 110. The second belt 120 has a second flat band part 121 and a plurality of second engaging parts 122 arranged in a plurality of rows along the longitudinal direction of the second belt 120. The second flat band part 121 is a flat band-like part without protrusions or recesses. The second engaging parts 122 are arranged in two rows at regular intervals along the longitudinal direction of the second belt 120. The second engaging parts 122 are configured to engage with and disengage from the first engaging parts 112.

In the pipe structure 100 shown in the lower part of FIG. 2, the first belt 110 is wound at a constant pitch Pt along the axis CX. A distance Le between the two rows of the first engaging parts 112 along the direction of the axis CX is equal to ½ of a winding pitch Pt. These configurations are the same for the second belt 120.

The first belt 110 has a width W1, and the second belt 120 has a width W2. These width W1 and W2 are approximately equal and set to a value slightly smaller than that of the winding pitch Pt.

The first belt 110 and the second belt 120 are spirally wound, overlapping in a staggered manner by half of the winding pitch Pt. As a result, the first engaging parts 112 of the two rows of the first belt 110 engage with the second engaging parts 122 of the two second belts 120 overlapped on the inside of the first belt 110.

The expandable apparatus 60 can convey a package mounted on the mounting unit 50 in the vertical direction.

### First Embodiment

First, a problem in the expandable apparatus 60 according to the above reference example found by the present inventors will be explained. The present inventors have found that a large amount of stress is generated at the proximal end of the pipe structure 100, and more specifically, at the point where the spiral winding of the first belt 110 and the second belt 120 begins. If the above stress accumulates, the durability of the pipe structure 100 may be reduced. In a first embodiment, a conveyance system that improves the lifespan of the pipe structure 100 is achieved.

Referring to the drawings, the conveyance system according to the first embodiment will be described below. The conveyance system includes a conveyance robot for conveying a package. The conveyance system may further include a server for managing the delivery of packages by the conveyance robot. In this case, some of the functions provided by the conveyance robot according to the first embodiment may be provided in the server. It should be noted that a system whose processing is completed in the conveyance robot may also be included in the conveyance system according to the first embodiment.

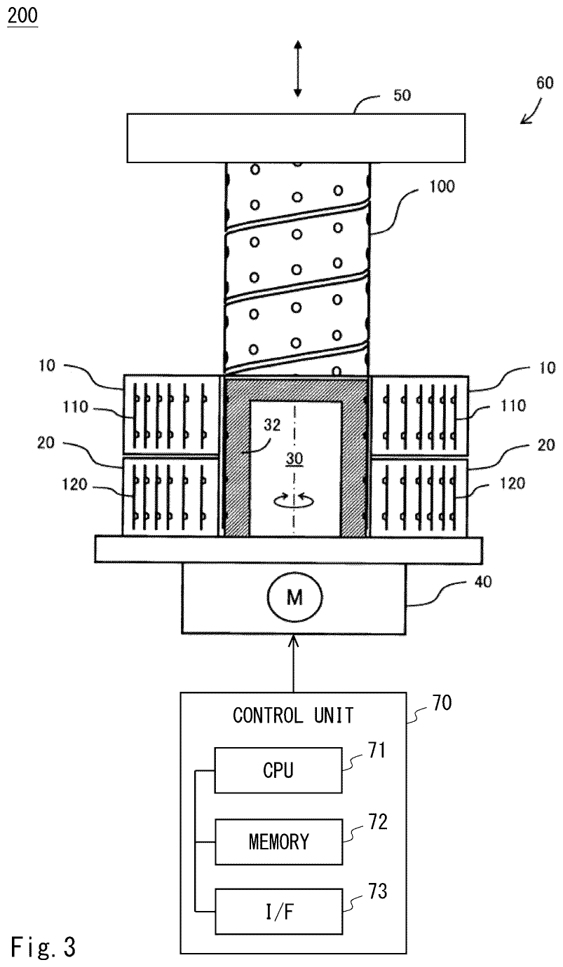

FIG. 3 is a diagram for explaining a configuration of a conveyance robot 200 according to the first embodiment. Hereinafter, the conveyance robot 200 according to the first embodiment will be described focusing on the differences between the expandable apparatus 60 according to the first embodiment and the expandable apparatus 60 according to the reference example, and the same configuration will be denoted by the same reference signs and the description will be omitted accordingly.

The conveyance robot 200 includes an expandable apparatus 60 and a control unit 70. The expandable apparatus 60 includes a pipe structure 100, a first housing unit 10, a second housing unit 20, a guide unit 30, a drive unit 40 for rotating a guide member 32 of the guide unit 30, and a mounting unit 50. A package is mounted on the mounting unit 50. The mounting unit 50 may be provided with a groove that fits a guide rail extending in the vertical direction.

For example, a package may be transferred between the mounting unit 50 and a shelf (not shown). The package mounted on the mounting unit 50 is conveyed, and the conveyed package is transferred to the shelf. The package transferred from the shelf to the mounting unit 50 is conveyed by the conveyance robot 200.

The control unit 70 has a hardware configuration centered on a microcomputer composed of, for example, a CPU (Central Processing Unit) 71, a memory 72, and an interface unit (I/F) 73. The CPU 71 performs control processing, arithmetic processing, and the like. The memory 72 includes a ROM (Read Only Memory) in which control programs, arithmetic programs, and the like executed by the CPU 71 are stored. The interface unit 73 inputs and outputs signals to and from the outside. The CPU 71, the memory 72, and the interface unit 73 are connected to each other via a data bus. The functions of the control unit 70 will be described later.

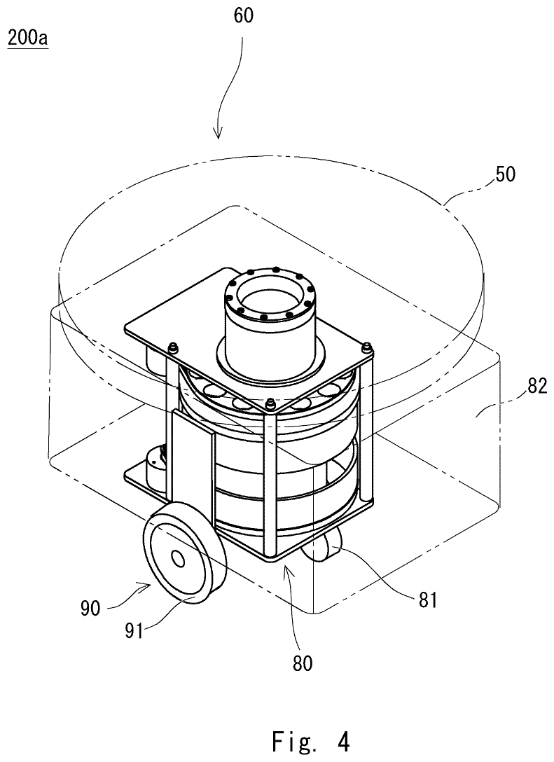

Next, with reference to FIG. 4, a conveyance robot 200a, which is an example of the conveyance robot 200, will be described. FIG. 4 is a perspective view schematically showing the conveyance robot 200a.

As shown in FIG. 4, the conveyance robot 200a includes an expandable apparatus 60, a base unit 80, and a moving unit 90. The expandable apparatus 60 includes a mounting unit 50. An upper surface of the mounting unit 50 may be circular or rectangular. The base unit 80 supports the expandable apparatus 60 in an expandable manner. Swivel casters 81, for example, are provided at the front end and rear end of the lower surface of the base unit 80. The base unit 80 may be covered with, for example, an cover 82.

The moving unit 90 includes left and right drive wheels 91 and a motor (not shown). The left and right drive wheels 91 and the motor are supported by the base unit 80. The conveyance robot 200a moves forward, backward, and turns, for example, by individually rotating the left and right drive wheels 91. The conveyance robot 200a may operate by autonomous control or in response to external instructions.

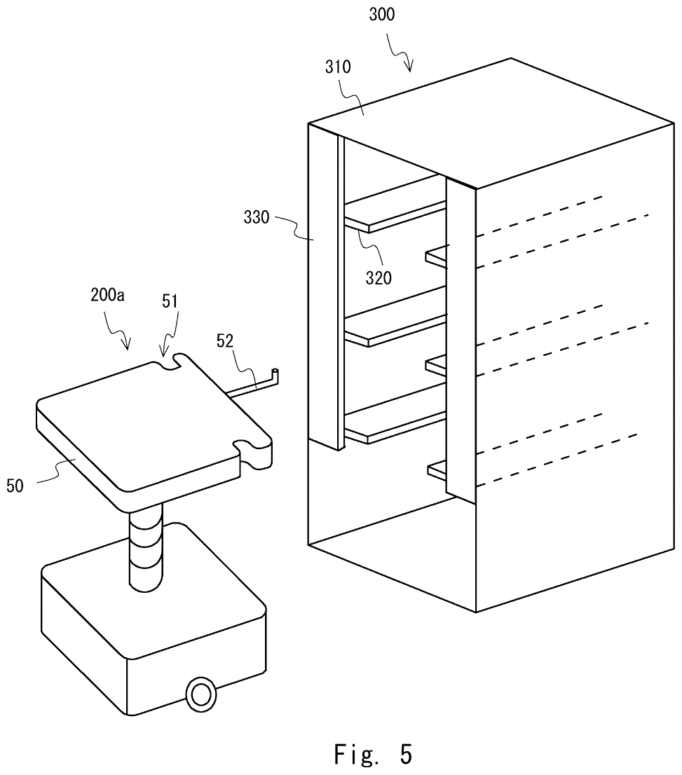

FIG. 5 is an explanatory diagram showing an example of a configuration of a shelf 300 for accommodating packages. The shelf 300 accommodates packages (e.g., returnable boxes) not shown. The shelf 300 includes a casing 310, support members 320, and guide rails 330. The support members 320 support both sides of a package accommodated in the shelf 300. The guide rails 330 fits with grooves 51 provided in the mounting unit 50. The guide rails 330 extend in the vertical direction. A gap is formed between the lower end of the guide rails 330 and the floor or the like, through which the conveyance robot 200, with the lowered mounting unit 50, can enter.

A description will now be given of an operation in which the conveyance robot 200a takes in and takes out a package from the shelf 300. The conveyance robot 200 first lowers the height of the mounting unit 50 below the lower end height of the guide rails 330 and enters the gap provided under the guide rails 330. The conveyance robot 200 then raises the mounting unit 50 to fit the grooves 51 into the guide rails 330 and raises the mounting unit 50 to the desired height along the guide rails 330. The package is then transferred by an extendable arm 52 provided in the mounting unit 50. The package may be transferred by means other than the extendable arm 52.

Referring back to FIG. 3, the function of the control unit 70 will be described. The control unit 70 controls the height of the mounting unit 50 by transmitting a control signal to the drive unit 40. For example, when a package is transferred between the mounting unit 50 and the shelf, or when the height of the mounting unit 50 is lowered, the height of the mounting unit 50 needs to be controlled. Lowering the height of the mounting unit 50 may be necessary, for instance, when the height of the mounting unit 50 needs to be lower than the height of the lower end of the guide rails. Additionally, during the movement of the conveyance robot 200a, there are situations where the height of the mounting unit 50 needs to be lowered.

When controlling the height of the mounting unit 50, the control unit 70 is configured to select one of a plurality of candidates for the height of the mounting unit 50. For example, the plurality of candidates are included in a height range of the mounting unit 50 that allows a package to be transferred to or from a package mounting unit (e.g., shelf). For example, the plurality of candidates are included in the height range lower than a predetermined height. Each candidate may be a specific height position or fall within a wide position range.

The control unit 70 has a function (this function is referred to as a selection function) to select a height at which the mounting unit 50 is to be stopped from among a plurality of candidates based on a history (referred to as a height history) of the heights at which the mounting unit 50 has stopped in the past. The control unit 70 can smooth out the stress accumulated in the first belt 110 and the second belt 120 by referring to the height history.

The control unit 70, for example, may choose a candidate for the height of the mounting unit 50 based on the relatively fewer number of times the mounting unit 50 has stopped in the past among the plurality of candidates. This helps distribute high stress points along the first belt 110 and the second belt 120.

Furthermore, the control unit 70 may select a candidate for the height of the mounting unit 50 that is different from the height at which the mounting unit 50 stopped most recently. By avoiding the consecutive selection of the same candidate, it is possible to prevent the accumulation of stress.

When lowering the height of the mounting unit 50 below a predetermined height, the control unit 70 selects the height of the mounting unit 50 from among the plurality of candidates within a height range lower than the predetermined height. For example, there may be situations where it is desirable to lower the height of the mounting unit 50 during the movement of the conveyance robot 200a. Additionally, there might be situations where the height of the mounting unit 50 needs to be lower than the lower end height of the guide rails.

When the control unit 70 lowers the height of the mounting unit 50 below a predetermined height, it may preferentially select a relatively higher candidate from among the plurality of candidates. Relatively lower candidates are more likely to be selected when there are strict restrictions on the height of the mounting unit 50. Therefore, by prioritizing the selection of relatively higher candidates, the control unit 70 can smooth out the frequency of selection among the plurality of candidates.

The control unit 70 may, for example, use a candidate h, which minimizes a value of an evaluation function f(h) shown in Expression (1), as an actual command value.

$$f ( h ) = ( ( number of stops ) + {log}_{10} ( weight ) * α ) - h * β \qquad ( 1 )$$

“h” represents each candidate. “Number of stops” represents the number of times the mounting unit 50 has stopped at the candidate “h” in the past. “Weight” represents an average weight of the packages mounted on the mounting unit 50. Note that “weight” may include the weight of the mounting unit 50. Additionally, “weight” may be a constant independent of the weight of the package (e.g., the weight of the mounting unit 50). “a” is a coefficient determined by the S-N(Stress-Number of cycles to failure) diagram of the material forming the first belt 110 and the second belt 120. “B” is a weighting coefficient for prioritizing the selection of higher candidates.

First, the first term of Expression (1) will be described. The first term is derived based on the general S-N curve, where the common logarithm of the number of cycles and the stress are inversely proportional. If the durability of the first belt 110 and the second belt 120 decreases due to modes other than fatigue failure, such as wear, Expression (1) may not hold. In such cases, Expression (1) may be modified according to each mode.

Next, the second term of Expression (1) will be described. The second term ensures that higher candidates are prioritized. The weighting coefficient β may be set to an appropriate value based on the upper limit of the “number of stops” or a predetermined height. Note that in Expression (1), subtraction is used as an operation for the calculation involving the first and second terms, but other operations such as division or exponentiation may also be used.

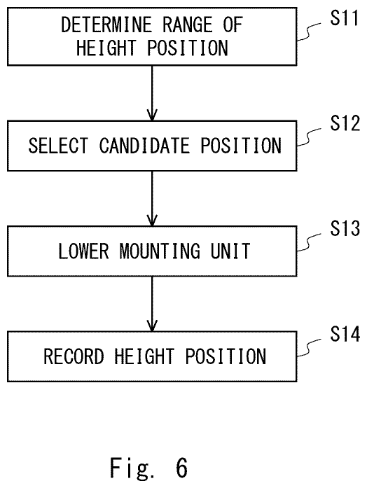

FIG. 6 is a diagram for explaining an example of an operation of the conveyance robot 200 according to the first embodiment. An operation of the conveyance robot 200 when the height of the mounting unit 50 is made lower than the predetermined height will be described below.

First, the control unit 70 of the conveyance robot 200 determines a height range acceptable as the height of the mounting unit 50 (step S11). The above range is determined according to the operation performed by the conveyance robot 200.

Next, the control unit 70 selects one of a plurality of candidates included in the determined height range based on the above Expression (1) or the like (step S12). Information indicating the selected candidate is passed to the drive unit 40 as a command value.

Next, the drive unit 40 lowers the mounting unit 50 based on the received command value (step S13). Next, the control unit 70 measures the height at which the mounting unit 50 has stopped based on the detection result of a sensor provided on the mounting unit 50 or the like, and records the measured height in the height history (step S14). When the measured value is recorded, the height history is recorded more accurately than when the command value is recorded. After step S14, the conveyance robot 200 performs the following operations.

Returning to FIG. 3, the control unit 70 may select a height at which the mounting unit 50 is to be stopped based further on a history of the weights of the packages previously mounted on the mounting unit 50 (the history is referred to as a weight history). When the package mounted on the mounting unit 50 is heavy, the stress generated in the first belt 110 and the second belt 120 may be large. For example, the control unit 70 may select the height of the mounting unit 50 in a way that makes it less likely to select the height at which the mounting unit 50 with a heavy package has stopped in the past.

By the way, when the package is transferred by an extendable arm or the like provided in the mounting unit 50, a large stress (e.g., compressive stress, tensile stress) is generated at the proximal end of the pipe structure 100. Therefore, it is desirable to distribute the points where stress is generated. The conveyance robot 200 can achieve stress distribution by selecting the height of the mounting unit 50 based on the height history. Additionally, since the stress is greater when the weight of the package is heavier, the stress accumulated on the first belt 110 and the second belt 120 can be smoothed out based on the weight history.

The conveyance system according to the first embodiment prevents the stress from accumulating at specific points in the two belts. This improves the lifespan of the expandable pipe structure formed by spirally winding the two belts.

The conveyance system may not necessarily have all functional elements centralized in the conveyance robot 200. For example, the selection function of the control unit 70 may be performed by an arithmetic unit provided by a server connected to the conveyance robot 200 via a network. In this case, the server transmits the selected candidate to the conveyance robot 200. The height history, weight history, and the like may be stored in the server. Thus, the conveyance system may be configured to include the server and the conveyance robot 200. The processor and memory described above may be located in the server or may be present in both the conveyance robot 200 and the server.

The above-described program includes instructions (or software codes) that, when loaded into a computer, cause the computer to perform one or more of the functions. The program may be stored in a non-transitory computer readable medium or a tangible storage medium. By way of example, and not a limitation, non-transitory computer readable media or tangible storage media can include a random-access memory (RAM), a read-only memory (ROM), a flash memory, a solid-state drive (SSD) or other types of memory technologies, a CD-ROM, a digital versatile disc (DVD), a Blu-ray disc or other types of optical disc storage, and magnetic cassettes, magnetic tape, magnetic disk storage or other types of magnetic storage devices. The program may be transmitted on a transitory computer readable medium or a communication medium. By way of example, and not a limitation, transitory computer readable media or communication media can include electrical, optical, acoustical, or other forms of propagated signals.

It should be noted that the present disclosure is not limited to the above embodiments and may be modified accordingly to the extent that it does not deviate from the purpose.

From the disclosure thus described, it will be obvious that the embodiments of the disclosure may be varied in many ways. Such variations are not to be regarded as a departure from the spirit and scope of the disclosure, and all such modifications as would be obvious to one skilled in the art are intended for inclusion within the scope of the following claims.

What is claimed is:

1. A conveyance system comprising:
a pipe structure formed by spirally winding a first belt and a second belt arranged inside the first belt around an axis;
a drive unit configured to vertically expand and contract the pipe structure;
a mounting unit attached to a tip of the pipe structure; and
a control unit configured to select a height at which the mounting unit is to be stopped from among a plurality of candidates for the height based on a height history of the heights at which the mounting unit has stopped in the past.

2. The conveyance system according to claim 1, wherein the control unit selects, from among the plurality of candidates for the height, a candidate for the height at which the number of times that the mounting unit has stopped in the past is relatively small.

3. The conveyance system according to claim 1, wherein the control unit preferentially selects a relatively higher candidate from among the plurality of candidates for the height included in a height range lower than a predetermined height when the height at which the mounting unit is to be stopped is lower than the predetermined height.

4. The conveyance system according to claim 1, wherein the control unit further selects the height at which the mounting unit is to be stopped based on a weight history of weights of packages mounted on the mounting unit in the past.

5. The conveyance system according to claim 1, wherein the control unit selects a candidate for the height that differs from the height at which the mounting unit stopped most recently.
